(19) United States
(12) Patent Application Publication
(10) Pub. No.: US 2019/0064433 A1
(43) Pub. Date: Feb. 28, 2019

(54) OPTICAL FIBER

(71) Applicant: SUMITOMO ELECTRIC INDUSTRIES, LTD., Osaka (JP)

(72) Inventors: Yuya HOMMA, Osaka (JP); Kazuyuki SOHMA, Osaka (JP); Kensaku SHIMADA, Osaka (JP)

(73) Assignee: SUMITOMO ELECTRIC INDUSTRIES, LTD., Osaka (JP)

(21) Appl. No.: 16/110,114

(22) Filed: Aug. 23, 2018

(30) Foreign Application Priority Data
Aug. 28, 2017 (JP) 2017-163234

(51) Int. Cl. G02B 6/02; C09D 133/14; C03C 25/1065; C03C 25/326; C03C 25/36

(52) U.S. Cl. CPC G02B 6/02395; C09D 133/14; C03C 25/36; C03C 25/326; C03C 25/1065

(57) ABSTRACT

An optical fiber comprising: a glass fiber including a core and a cladding; and a coating layer coating an outer periphery of the glass fiber; wherein the coating layer includes a primary coating layer and a secondary coating layer, and a hardness at a depth of 200 nm from a surface of the secondary coating layer, H_{IT-200 nm}, is 0.02 to 0.20 GPa as measured with a nano indenter.

### TECHNICAL FIELD

The present invention relates to optical fibers. This application claims a priority based on Japanese Patent Application No. 2017-163234, filed on Aug. 28, 2017, the entire content of which is incorporated herein by reference.

### BACKGROUND

A coated optical fiber including a primary coating layer and a secondary coating layer on the outer periphery of an optical fiber has been known (see, for example, Patent Literature 1).

### Patent Literature 1: Japanese Unexamined Patent Publication No. 2000-241680

### SUMMARY

An optical fiber according to one aspect of the present invention is an optical fiber comprising: a glass fiber including a core and a cladding; and a coating layer coating an outer periphery of the glass fiber; wherein the coating layer includes a primary coating layer and a secondary coating layer, and a hardness at a depth of 200 nm from a surface of the secondary coating layer, H_{IT-200 nm}, is 0.02 to 0.20 GPa as measured with a nano indenter.

### BRIEF DESCRIPTION OF THE DRAWINGS

FIG. 1 is a schematic sectional view illustrating one example of the optical fiber according to the present invention.

### DETAILED DESCRIPTION

Patent Literature 1 focuses on the Youngs modulus of the coating layer in view of providing a coated optical fiber exhibiting low transmission loss and having excellent lateral pressure properties and anti-peeling properties. However, the optical fiber obtained according to the description of the literature may suffer external flaws such as cuts and depressions on the surface of the secondary coating layer that sometimes occur during running of the optical fiber, winding defects of the optical fiber, and the like.

Then, an object of the present invention is to provide an optical fiber that enables reduction in at least winding defects sufficiently.

### Description of Embodiment According to the Present Invention

First, the content of the embodiment according to the present invention will be detailed and described. The optical fiber according to an embodiment of the present invention is as follows.

(1) The optical fiber is an optical fiber including: a glass fiber comprising a core and a cladding; and a coating layer coating an outer periphery of the glass fiber; wherein the coating layer comprises a primary coating layer and a secondary coating layer, and a hardness at a depth of 200 nm from a surface of the secondary coating layer, H_{IT-200 nm}, is 0.02 to 0.20 GPa as measured with a nano indenter. The optical fiber of the present embodiment can reduce at least winding defects sufficiently. As mentioned above, Patent Literature 1 focuses on the Young's modulus of a coating layer, but the physical property values evaluated therein are just average values in a coating layer. In contrast, the inventors have found that studies on the physical property values of the very surface local area are important for reduction in winding defects, and thus have made the optical fiber of the aspect described above.

(2) It is preferable that in the optical fiber, the secondary coating layer be a cured product of a resin composition comprising an epoxy (meth)acrylate. Thereby, a secondary coating layer excellent in terms of surface hardness and fast curability can be formed.

(3) It is preferable that in the optical fiber, the secondary coating layer be a cured product of a resin composition comprising 1-hydroxycyclohexyl phenyl ketone. Thereby, a secondary coating layer excellent in surface hardness can be formed.

(4) It is preferable that in the optical fiber, the Young's modulus of the secondary coating layer be 0.5 to 2.0 GPa at 23° C.

According to the present invention, an optical fiber that enables reduction in at least winding defects sufficiently can be provided.

### Detailed Description of Embodiment According to the Present Invention

Hereinafter, specific examples of the optical fiber according to an embodiment of the present invention will be described with reference to the drawings. The present invention will not be limited to these examples, but is defined by Claims and intended to include all modifications within the meaning and scope of equivalency of Claims. In the following description, identical reference numbers will be given to identical components in the description of drawings, and the duplication of description will be omitted.

(Optical Fiber)

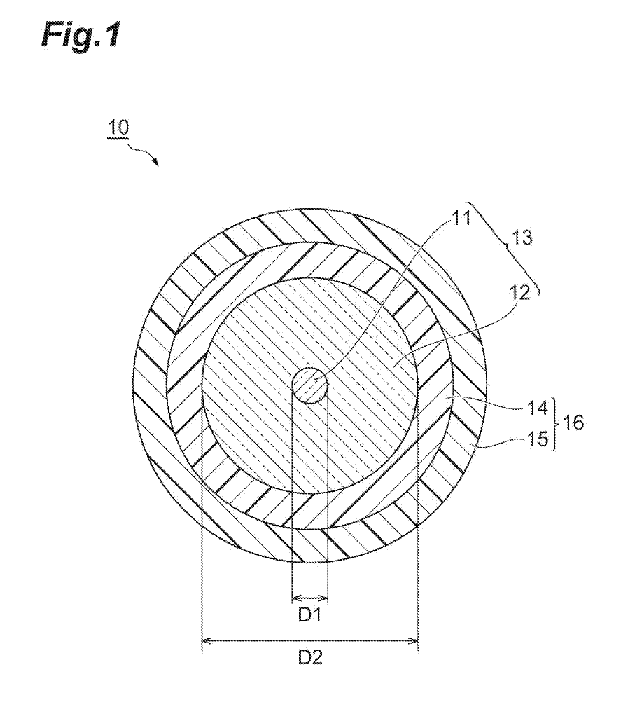

FIG. 1 is a schematic sectional view illustrating one example of the optical fiber according to an embodiment of the present invention. Art optical fiber 10 includes a glass fiber 13 comprising a core 11 and a cladding 12, and a coating layer 16 including a primary coating layer 14 and a secondary coating layer 15, disposed on the outer periphery of the glass fiber 13. The primary coating layer and the secondary coating layer are each formed of a prescribed resin composition, as described later, and can therefore be referred to as a primary resin layer and a secondary resin layer, respectively.

The cladding 12 surrounds the core 11. The core 11 and the cladding 12 mainly contain glass such as quartz glass; for example, a quartz to which germanium is added can be used as the core 11, and pure quartz or a quartz to which fluorine is added can be used as the cladding 12.

In FIG. 1, for example, the outer diameter (D2) of the glass fiber 13 is about 125 μm. The diameter (D1) of the core 11 fowling the glass fiber 13 is about 7 to 15 μm. The coating layer 16 has at least a two-layered structure including the primary coating layer 14 and the secondary coating layer 15. The total thickness of the coating layer 16 is usually about 60 μm; the thicknesses of the primary coating layer 14 and the secondary coating layer 15 are almost same and the thickness of each layer is 20 to 40 μm. For example, the thickness of the primary coating layer 14 may be 35 μm and the thickness of the secondary coating layer 15 may be 25 μm. In the case where a large number of the optical fibers are bundled to make a cable, the coating diameter of the optical fiber is preferably thin. In this case, the total thickness of the coating layer 16 is preferably 30 to 40 μm.

The hardness at a depth of 200 nm from the surface of the secondary coating layer (the hardness at the position 200 nm below the surface), H_{IT-200 nm}, is 0.02 to 0.20 GPa. If H_{IT-200 nm} is less than 0.02

GPa, the surface of the secondary coating is so soft that the secondary coating has tackiness such that winding defects of the optical fiber occur easily. If H_{IT-200 nm}, is more than 0.20 GPa, the adhesion to an ink layer is likely to decrease. In view of these, it is preferable that H_{IT-200 nm} be 0.04 to 0.18 GPa. The ink layer herein refers to a coloring layer that may be further disposed on the outer periphery of the secondary coating layer to distinguish optical fibers.

The hardness H_{IT} as measured with a nano indenter can be obtained by a test method according to ISO 14577. When a Berkovich indenter is used, it can be obtained from the following calculation formula:

H_{IT}=Fₘₐₓ/23.96 hc²

hc=hₘₐₓ−0.75(hₘₐₓ−hᵣ)

wherein Fₘₐₓ is the maximum test loading, hₘₐₓ is the maximum depth of the indentation, and hᵣ is the depth obtained from the inclination (the tangent line) of the curve of the initial phase of the elastic recovery.

It is preferable that the Young's modulus of the secondary coating layer be 0.5 to 2.0 GPa at 23° C. When the Young's modulus is less than 0.5 GPa, the anti-microbend property may be poor. When the Young's modulus is more than 2.0 GPa, the coating is brittle, and therefore cracks are likely to develop.

The Young's modulus of the secondary coating layer can be measured as follows. The optical fiber, is first immersed in a mixed solvent of acetone and ethanol, and only the coating layer in a tubular form is pulled out. Although the primary coating layer and the secondary coating layer are integrated at this time, the primary coating layer can be disregarded, because the primary coating layer has a Young's modulus that is one one-thousandth to one ten-thousandth of the secondary coating layer. Next, the coating layer was dried in vacuo to remove the solvent, and then the tensile test is performed (the tension speed is 1 nun/min) in a thermostatic chamber at 23° C. The Young's modulus can be determined from the secant formula at 2.5% strain.

The Young's modulus of the primary coating layer is preferably 0.05 to 0.5 MPa at 23° C., more preferably 0.08 to 0.25 MPa. When the Young's modulus is less than 0.05 MPa, cracks (voids) are likely to develop in the primary coating layer by the external force. When the Young's modulus is more than 0.5 MPa, the anti-macrobend property is poor.

The Young's modulus of the primary coating layer can be measured by a pullout modulus test.

The primary coating layer and the secondary coating layer can be formed, for example, by curing an ultraviolet light curable resin composition comprising a urethane (meth)acrylate oligomer, a monomer, and a photopolymerization initiator.

Examples of the urethane (meth)acrylate oligomer include oligomers obtained by reacting a polyol, a polyisocyanate, and a hydroxyl group-containing (meth)acrylate.

The term (meth)acrylate indicates acrylate or its corresponding methacrylate. The same is true of the term (meth)acrylic acid.

Examples of the polyol include polytetramethylene glycol, polypropylene glycol, and bisphenol A.ethylene oxide addition dial.

Examples of the polyisocyanate include 2,4-tolylene diisocyanate, 2,6-tolylene diisocyanate, isophorone diisocyanate, and dicyclohexylmethane 4,4′-diisocyanate.

Examples of the hydroxyl group-containing (meth)acrylate include 2-hydroxyethyl acrylate, 2-hydroxybutyl acrylate, 1,6-hexanediol monoacrylate, pentaerythritol triacrylate, and 2-hydroxypropyl acrylate.

An organic tin compound can be used as a catalyst during synthesis of the urethane (meth)acrylate oligomer. Examples of the organic tin compound include dibutyltin dilaurate, dibutyltin diacetate, dibutyltin maleate, dibutyltin bis(2-ethylhexyl mercaptoacetate), dibutyltin bis(isooctyl mercapto acetate), and dibutyltin oxide. From the viewpoint of availability and catalyst performance, it is preferable that dibutyltin dilaurate or dibutyltin diacetate be used as a catalyst.

A lower alcohol having 5 or less carbon atoms may be used during synthesis of the urethane (meth)acrylate oligomer. Examples of the lower alcohol having 5 or less carbon atoms include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol. In view of the reduction in the Young's modulus, it is preferable to use an alcohol for the synthesis when the primary coating layer is formed, and it is preferable to use no alcohol for the synthesis when the secondary coating layer is formed.

Hereinafter, preparation of the urethane (meth)acrylate oligomer will be described by reference to a specific example. For example, if polypropylene glycol as a polyol, isophorone diisocyanate as a polyisocyanate, 2-hydroxyethyl acrylate as a hydroxyl group-containing (meth)acrylate, and methanol as an alcohol are used, a urethane (meth)acrylate oligomer containing three reaction products shown below can be obtained,
(1) H-I-(PPG-I)n-H
(2) H-I-(PPG-I)n-Me
(3) Me-I-(PPG-I)n-Me
   where H represents the residue of 2-hydroxyethyl acrylate, 1 represents the residue of isophorone diisocyanate, PPG represents the residue of polypropylene glycol, Me represents the residue of methanol, and n represents an integer of 1 or more.

The reaction product (1) is a reactive oligomer having a (meth)acryloyl group at each of two terminals and therefore, the crosslinking density of the cured product can be increased. The reaction product (2) is a reactive oligomer having a (meth)acryloyl group at its one terminal, and therefore, the reaction product (2) has the effect of reducing the crosslinking density of the cured product, and can reduce the Young's modulus. The reaction product (3) is a non-reactive oligomer having no (meth)acryloyl group and does not contribute to curing with ultraviolet light; therefore, it is preferable that preparation be performed such that the amount of the reaction product (3) is minimized.

When the urethane (meth)acrylate oligomer is synthesized, a silane coupling agent having a functional group reactive with the isocyanate group may be used. Examples of the silane coupling agent having a functional group reactive with the isocyanate group include N-2-(aminoethyl)-3-amninopropylmethyldimethoxysilane, N-2-(aminoethyl)-3-aminopropyltrimethoxysilane, 3-aminopropyltrimethoxysilane, 3-aminopropyltriethoxysilane, 3-mercaptopropylmethyldimethoxysilane, and 3-mercaptopropyltrimethoxysilane. If the polyol compound is reacted with the isocyanate compound, the hydroxyl group-containing (meth)acrylate compound and the silane coupling agent are used in combination in the state where an isocyanate group is present on both ends, and are reacted with the isocyanate group, a two-terminal reactive urethane (meth)acrylate oligomer and additionally a one-terminal silane coupling agent addition urethane (meth)acrylate oligomer can be synthesized. As a result, because the oligomer can be reacted with glass, the adhesion between the glass fiber 13 and the primary coating layer 14 can be enhanced.

As a monomer, a monofunctional monomer having one polymerizable group, or a polyfunctional monomer having two or more polymerizable groups can be used. These monomers may be used in the form of a mixture thereof.

Examples of the monofunctional monomer include (meth)acrylate monomers such as methyl (meth)acrylate, ethyl (meth)acrylate, propyl (meth)acrylate, n-butyl (meth)acrylate, s-butyl (meth)acrylate, t-butyl (meth)acrylate, isobutyl (meth)acrylate, n-pentyl (meth)acrylate, isopentyl (meth)acrylate, hexyl (meth)acrylate, heptyt (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, phenoxyethyl (meth)acrylate, tetrahydrofurfuryl (meth)acrylate, benzyl (meth)acrylate, dicyclopentanyl (meth)acrylate, dicyclopentenyloxyethyl (meth)acrylate, dicyclopentanyl (meth)acrylate, nonylphenol polyethylene glycol (meth)acrylate(e.g. SR504, manufactured by Sartomer), nonylphenoxypolyethylene glycol (meth)acrylate, and isobomyl (meth)acrylate; carboxyl group-containing monomers such as (meth)acrylic acid, (meth)acrylic acid dimers, carboxyethyl (meth)acrylate, carboxypentyl (meth)acrylate, and co-carboxy-polycaprolactone (meth)acrylate; heterocycle-containing monomers such as 4-acryloylmorpholine, N-vinylpyrrolidone, N-vinylcaprolactam, N-acryloylpiperidine, N-methacryloylpiperidine, and N-acryloylpyrrolidine; maleimide, N-cyclohexylmaleimide, and N-phenylmaleimide; N-substituted amide monomers such as (meth)acrylamide, N,N-dimethyl(meth)acrylamide, N,N-, diethyl(meth)acrylamide, N-hexyl(meth)acrylamide, N-methyl(meth)acrylamide, N-butyl(meth)acrylamide, N-methylol(meth)acrylamide, and N-methylolpropane(meth)acrylamide; aminoalkyl (meth)acrylate monomers such as aminoethyl (meth)acrylate, aminopropyl (meth)acrylate, N,N-dimethylaminoethyl (meth)acrylate, t-butylaminoethyl (meth)acrylate and 3-(3-Pyridinyl) propyl(meth)acrylate.

Examples of the polyfunctional monomer include bifunctional monomers such as ethylene glycol di(meth)acrylate, polyethylene glycol di(meth)acrylate, polypropylene glycol di(meth)acrylate, neopentyl glycol di(meth)acrylate, triethylene glycol di(meth)acrylate, tripropylene glycol di(meth)acrylate, tetraethyl ene glycol di(meth)acrylate, hydroxy pivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyl diol di(meth)acrylate, 3-ethyl-1,8-octanediol di(meth)acrylate; epoxy (meth)acrylates such as di(meth)acrylate of an EO adduct of bisphenol A (e.g., Viscoat #700, manufactured by OSAKA ORGANIC CHEMICAL INDUSTRY LTD.) and di(meth)acrylate of an acrylate adduct of Bisphenoi A diglycidyl ether (e.g., Viscoat #540, manufactured by OSAKA ORGANIC CHEMICAL INDUSTRY LTD.); monomers of tri functions or more such as trimethylolpropane tri(meth)acrylate, trimethyloloctane tri(meth)acrylate, trimethylolpropanepolyethoxy tri(meth)acrylate, trimethylolpropanepolypropoxy tri(meth)acrylate, trimethylolpropanepolyethoxypolypropoxy tri(meth)acrylate, tris[(meth)acryloyloxyethyl] isocyanurate, pentaerythritol tri(meth)acrylate, pentaerythritolpolyethoxy tetra(meth)acrylate, pentaerythritolpolypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate. In view of the excellent surface hardness, it is preferable that the ultraviolet light curable resin composition forming the secondary coating layer contain an epoxy (meth)acrylate among others.

The photopolymerization initiator can be appropriately selected from known radical photopolymerization initiators; examples of the photopolymerization initiator include 1-hydroxycyclohexylphenyl ketone(Irgacure 184, manufactured by BASF SE), 2,2-dimethoxy-2-phenylacetophenone, 1-(4-isopropylphenyl)-2-hydroxy-2-methylpropan-1-one, 2,4,4-trimethylpentylphosphine oxide, 2,4,4-trimethylbenzoyldiphenylphosphine oxide, 2-methyl-1-[4-(methylthio)phenyl]-2-morpholino-propan-1-one (Irgacure 907, manufactured by BASF SE), 2,4,6-trimethylbenzoyldiphenylphosphine oxide (Irgacure TPU, manufactured by BASF SE), and bis(2,4,6-trimethylbenzoyl)phenylphosphine oxide (Irgacure 819, manufactured by BASF SE).

These photopolymerization initiators may be used in the form of a mixture thereof, and the photopolymerization initiator preferably comprises at least 2,4,6-trimethylbenzoyldiphenylphosphine oxide. 2,4,6-Trimethylbenzoyldiphenylphosphine oxide brings about excellent quick curing properties of resins. It is preferable that the ultraviolet light curable resin composition forming the secondary coating layer further contain 1-hydroxycyclohexyl phenyl ketone. It can contribute to the increase in the surface hardness.

The ultraviolet light curable resin composition forming the primary coating layer may further comprise a silane coupling agent, a photo acid generator, a leveling agent, an antifoaming agent, and an antioxidant.

The silane coupling agent is not particularly limited as long as it does not obstruct curing of the ultraviolet light curable resin composition, and a variety of silane coupling agents including publicly known and used silane coupling agents can be used. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyltrimethoxysilane, γ-glycidoxypropyltrimethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3 -(triethoxysilyl)propyl]tetrasulfide, bis-[3-(triethoxysily)propyl]disulfide, γ-trimethoxysilylpropyldimethylthiocarbamyl tetrasulfide, and γ-trimethoxysilylpropylbenzothiazyl tetrasulfide. By use of the silane coupling agent, the adhesion between the glass fiber 13 and the primary coating layer 14 can be controlled, or dynamic fatigue properties can be improved.

As the photo acid generator, an onium salt having a structure represented by A⁺B⁻ may be used. Examples of the photo acid generator include sulfonium salts such as UVACURE 1590 (manufactured by DAICEL-CYTEC Company, Ltd.), and CPI-100P and 110P (manufactured by San-Apro Ltd.); and iodonium salts such as IRGACURE 250 (manufactured by BASF SE), WPI-113 (manufactured by Wako Pure Chemical Industries, Ltd.), and Rp-2074 (manufactured by Rhodia Japan, Ltd.).

### EXAMPLES

Hereinafter, the results of evaluation tests using Examples and Comparative Examples according to the present invention will be shown, and the present invention will be described more in detail. The present invention will not be limited to these Examples.

[Resin Composition for Primary Coating Layer]

Urethane (meth)acrylate oligomer was synthesized by using polypropylene glycol having an average molecular weight of 4000 as a polyol, isophorone diisocyanate as a polyisocyanate, 2-hydroxyethyl acrylate as a hydroxyl group-containing (meth)acrylate, methanol as an alcohol, and dibutyltin dilaurate as an organotin catalyst.

Then, a resin composition for a primary coating layer was prepared using the urethane (meth)acrylate oligomer obtained; N-vinylcaprolactam, isobornyl acrylate, nonylphenol polyethylene glycol acrylate, and 1,6-hexanediol diacrylate, as monomers; and 2,4,6-trimethylbenzoyldiphenylphosphine oxide (Irgacure TPO, manufactured by BASF SE) as a photopolymerization initiator. At this time, the resin composition was prepared such that a primary coating layer obtained therefrom through curing had a Young's modulus of 0.15 MPa.

[Resin Composition for Secondary Coating Layer]

Urethane (meth)acrylate oligomer was synthesized by using polypropylene glycol having an average molecular weight of 600 as a polyol, isophorone diisocyanate as a polyisocyanate, 2-hydroxyethyl acrylate as a hydroxyl group-containing (meth)acrylate, and dibutyltin dilaurate as an organotin catalyst.

Then, a resin composition for a secondary coating layer was prepared using the urethane (meth)acrylate oligomer obtained and monomers and photopolymerization initiators shown Tables 1 and 2.

[Preparation of Optical Fiber 10]

A coating layer 16 (a primary coating layer 14 and a secondary coating layer 15) was formed using the resin composition for a primary coating layer and the resin composition for a secondary coating layer, on the outer surface of a glass fiber 13 composed of a core and a cladding to make an optical fiber 10. The thickness of the primary coating layer 14 was 35 μm and the thickness of the secondary coating layer 15 was 25 μm.

[Evaluation of Optical Fiber 10]

The resulting optical fibers were subjected to the following evaluation tests. The results are shown in Table 1 and Table 2.

(Measurement of Young's Modulus)

The optical fiber was immersed in a mixed solvent of acetone and ethanol, and only the coating layer in a tubular form was pulled out. Next, the coating layer was dried in vacuo to remove the solvent, and then the tensile test (the tension speed was 1 mm/min) was performed in a thermostatic chamber at 23° C. The Young's modulus of the coating layer was determined from the secant formula at 2.5% strain. The Young's modulus thus determined can be considered substantially as the Young's modulus of the secondary coating layer.

(Measurement of H_{IT})

The coating of the optical fiber was cut off with a razor, and the primary coating layer was then removed therefrom with tweezers to take only the secondary coating layer out. Then, the secondary coating layer was fixed to a glass plate via an adhesive with its surface up. H_{IT} in the depth direction (H_{IT-200 nm}) was measured with Nano Indenter XP manufactured by MTS Systems Corporation by the test method (Continuous Stiffness Measurement) according to ISO 14577. A Berkovich indenter was used as the indenter, and the measurement frequency was 45 Hz.

(Frequency of Winding Defects)

500 km of the optical fiber was re-wound at a fiber speed of 1000 m/min (50 km×10 bobbins), and then the longitudinal transmission loss in each bobbin was evaluated using OTDR (Optical Time Domain Refiectometer). The measurement wavelength was 1550 nm. The optical fiber was ranked as A when the number of point discontinuities of more than 0.05 dB was 2 or less per 500 km, as B when the number was 3 to 5 per 500 km, and as C when the number was 6 or more per 500 km; a rank equal to or higher than B was considered acceptable.

TABLE 1

| | | | Example | | | | | |
|---|---|---|---|---|---|---|---|---|
| | | | 1 | 2 | 3 | 4 | 5 | 6 |
| Resin | Urethane (meth)acrylate | wt % | 50 | 50 | 50 | 60 | 50 | 50 |
| composition | Viscoat #540 | wt % | 20 | 10 | 5 | 10 | 5 | — |
| for secondary | Isobornyl acrylate | wt % | 13 | 18 | 20 | 8 | 21 | 24 |
| coating layer | Triethylene glycol | wt % | 15 | 20 | 23 | 20 | 23 | 24 |
| | diacrylate | | | | | | | |
| | Irgacure TPO | wt % | 1 | 1 | 1 | 1 | 1 | 1 |
| | Irgacure 184 | wt % | 1 | 1 | 1 | 1 | — | 1 |
| Results of | Young's modulus of | MPa | 1040 | 1020 | 1010 | 880 | 1010 | 990 |
| evaluation of | secondary coating layer | | | | | | | |
| optical fiber | H_{IT-200 nm} | GPa | 0.19 | 0.11 | 0.04 | 0.10 | 0.03 | 0.02 |
| | Frequency of winding | — | A | A | A | A | B | B |
| | defects | | | | | | | |

TABLE 2

| | | | Comparative Example | |
|---|---|---|---|---|
| | | | 7 | 8 |
| Resin | Urethane (meth)acrylate | wt % | 50 | 60 |
| composition | Viscoat #540 | wt % | — | — |
| for secondary | Isobornyl acrylate | wt % | 40 | 20 |
| coating layer | Triethylene glycol | wt % | 9 | 19 |
| | diacrylate | | | |
| | Irgacure TPO | wt % | 1 | 1 |
| | Irgacure 184 | wt % | — | — |
| Results of | Young's modulus of | MPa | 1060 | 860 |
| evaluation of | secondary coating | | | |
| optical | layer | | | |
| fiber | H_{IT-200 nm} | GPa | 0.01 | 0.01 |
| | Frequency of winding | — | C | C |
| | defects | | | |

### REFERENCE SIGNS LIST

10: Optical fiber
11: Core
12: Cladding
13: Glass fiber
14: Primary coating layer
15: Secondary coating layer
16: Coating layer

What is claimed is:

1. An optical fiber comprising:
a glass fiber including a core and a cladding; and
a coating layer coating an outer periphery of the glass fiber;
wherein the coating layer includes a primary coating layer and a secondary coating layer, and
a hardness at a depth of 200 nm from a surface of the secondary coating layer, H_{IT-200 nm}, is 0.02 to 0.20 GPa as measured with a nano indenter.

2. The optical fiber according to claim 1, wherein the secondary coating layer is a cured product of a resin composition comprising an epoxy (meth)acrylate.

3. The optical fiber according to claim 1, wherein the secondary coating layer is a cured product of a resin composition comprising 1-hydroxycyclohexyl phenyl ketone.

4. The optical fiber according to claim 1, wherein a Young's modulus of the secondary coating layer is 0.5 to 2.0 GPa at 23° C.
